(19) United States
(12) Patent Application Publication
(10) Pub. No.: US 2026/0279702 A1
(43) Pub. Date: Sep. 17, 2026

(54) SWITCH SYSTEM

(71) Applicant: KABUSHIKI KAISHA TOKAI RIKA DENKI SEISAKUSHO, Aichi (JP)

(72) Inventors: Yosuke HATADA, Aichi (JP); Yuta YAMANISHI, Aichi (JP); Masahiro KATO, Aichi (JP); Sota SUZUKI, Aichi (JP)

(73) Assignee: KABUSHIKI KAISHA TOKAI RIKA DENKI SEISAKUSHO, Aichi (JP)

(21) Appl. No.: 19/473,257

(22) PCT Filed: Mar. 27, 2024
(86) PCT No.: PCT/JP2024/012305

§ 371 Date: Oct. 7, 2025

(30) Foreign Application Priority Data
Apr. 10, 2023 (JP) 2023-063547

(51) Int. Cl. H01H 21/22; B60R 16/027; H01H 21/12

(52) U.S. Cl. CPC H01H 21/22; B60R 16/027; H01H 21/12

(57) ABSTRACT

A movable contact is moved so as to electrically connect a first contact with at least one of a second contact and a third contact, thereby being capable of establishing multiple electrical connection states. A circuit board include a first area, a second area, and a third area. A signal line is connected in parallel with the second area and the third area. A first resistive element connected in parallel with the second contact and the third contact is mounted on the first area. A second resistive element connected in series with the second contact is mounted on the second area. The third area is substantially made open. A control device is configured to detect, through the signal line, which one of the electrical connection states is established, and to associate the one of the electrical connection state as detected with one of multiple controlled states.

### FIELD

The presently disclosed subject matter relates to a switch system including a switch device and a control device.

### BACKGROUND

Japanese Patent Publication No. 2015-108592A discloses a switch system adapted to be installed in a vehicle. The system includes a switch device and a control device. The switch device constitutes a part of a steering device for changing a traveling direction of the vehicle. The switch device establishes different electrical connection states in accordance with an actuation of an actuable member. The control device detects which one of the electrical connection states is established to cause a device installed in the vehicle to perform a corresponding operation.

### SUMMARY OF THE INVENTION

### Technical Problem

It is required to diversify models capable of installing a switch system while suppressing an increase in a manufacturing cost of the system.

### Solution to Problem

An illustrative aspect of the presently disclosed subject matter may provide a switch system, comprising:
a switch device; and
a control device,
wherein the switch device includes:
   a first stationary contact;
   multiple second stationary contacts;
   a movable contact configured to be moved so as to electrically connect the first stationary contact with at least one of the second stationary contacts, thereby being capable of establishing multiple electrical connection states;
   a circuit board including a first area, a second area, and a third area; and
   a signal line connected in parallel with the second area and the third area,
wherein at least one first resistive element connected in parallel with the second stationary contacts is mounted on the first area;
wherein a second resistive element connected in series with one of the second stationary contacts is mounted on one of the second area and the third area;
wherein the other of the second area and the third area is substantially made open; and
wherein the control device is configured to detect, through the signal line, which one of the electrical connection states is established, and to associate the one of the electrical connection state as detected with one of multiple controlled states.

According to the configuration as described above, by selecting one of the second area and the third area of a common circuit board on which a resistive element is to be mounted, it is possible to change a controlled state to be associated with a certain electrical connection state established on the circuit board. Accordingly, it is possible to diversify models capable of installing a switch system while suppressing an increase in a manufacturing cost of the system.

### BRIEF DESCRIPTION OF DRAWINGS

FIG. 1 illustrates an appearance of a switch device according to an exemplary embodiment.

FIG. 2 illustrates an appearance of the switch device of FIG. 1 as viewed from a direction along a turning axis.

FIG. 3 illustrates a state that a knob is removed from the switch device of FIG. 1.

FIG. 4 illustrates a cross section along a line IV-IV of FIG. 2 as viewed from an arrowed direction.

FIG. 5 illustrates a state that the knob is removed from the switch device of FIG. 1.

FIG. 6 illustrates an action of the switch device of FIG. 1.

FIG. 7 illustrates an action of the switch device of FIG. 1.

FIG. 8 illustrates an action of the switch device of FIG. 1.

FIG. 9 illustrates an exemplary configuration of a circuit board according to a first exemplary embodiment.

FIG. 10 illustrates another exemplary configuration of a circuit board according to the first exemplary embodiment.

FIG. 11 illustrates an exemplary configuration of a circuit board according to a second exemplary embodiment.

FIG. 12 illustrates another exemplary configuration of a circuit board according to the second exemplary embodiment.

FIG. 13 illustrates an exemplary configuration of a circuit board according to a third exemplary embodiment.

FIG. 14 illustrates another exemplary configuration of a circuit board according to the third exemplary embodiment.

### DESCRIPTION OF EMBODIMENTS

Exemplary embodiments will be described in detail below with reference to the accompanying drawings. In each of the drawings, the scale is appropriately changed in order to make each element illustrated have a recognizable size.

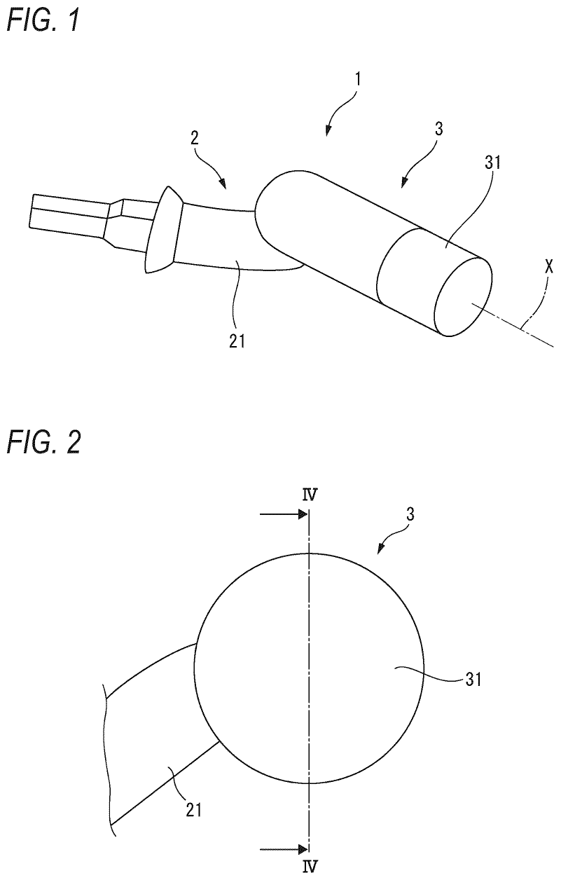

FIG. 1 illustrates an appearance of a switch device 1 according to an exemplary embodiment. The switch device 1 is installed in a vehicle to constitute a part of a steering device for changing a course of the vehicle.

The switch device 1 includes a lever switch 2. The lever switch 2 includes a lever 21 capable of being displaced with respect to the steering device. The lever switch 2 accepts an actuation involving the displacement in order to turn on a direction indicator of the vehicle, for example.

The switch device 1 includes a knob switch 3. The knob switch 3 includes a knob 31 that is turnable about a turning axis X. FIG. 2 illustrates an appearance of the knob switch 3 viewed from a direction along the turning axis X. The knob 31 accepts an actuation involving the turning in order to change, for example, a lighting state of a headlight of the vehicle. The knob 31 is an example of an actuable member. The headlight is an example of a device installed in a vehicle. The lighting state is an example of a controlled state.

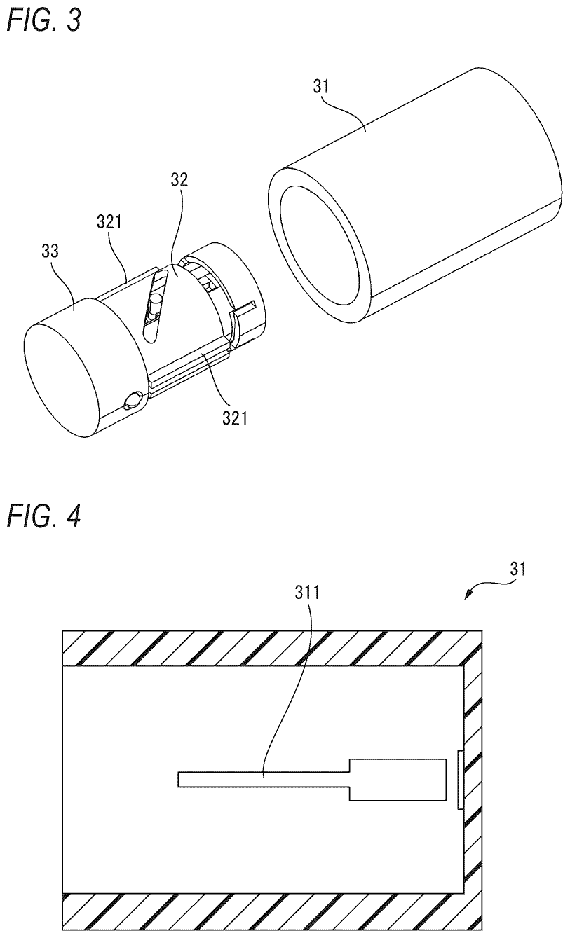

FIG. 3 illustrates an appearance of the knob switch 3 in a state that the knob 31 is removed. The knob switch 3 includes a rotor 32 and a stator 33. The stator 33 is fixed to the lever switch 2. The rotor 32 is supported by a stator 33 so as to be turnable about the turning axis X. An engagement member 321 is provided on an outer circumferential face of the rotor 32.

FIG. 4 illustrates a cross section of the knob 31 viewed from an arrowed direction along the line IV-IV in FIG. 2. An engagement member 311 is provided on an inner circumferential face of the knob 31. As the knob 31 is attached to the rotor 32, the engagement member 311 of the knob 31 engages with the engagement member 321 of the rotor 32. As a result, the rotor 32 is configured to be turnable about the turning axis X together with the knob 31. The stator 33 supports the knob 31 by way of the rotor 32.

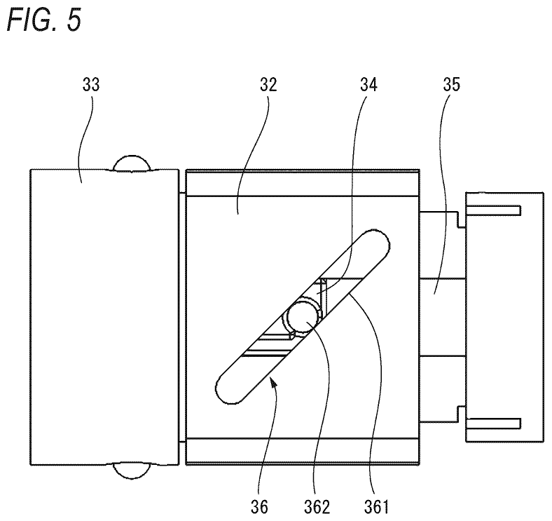

In FIG. 5, the knob switch 3 includes a slider 34 and a circuit board 35. The circuit board 35 has a shape elongated in a direction along the turning axis X. The slider 34 is mounted on the circuit board 35. Multiple stationary contacts are disposed on the circuit board 35. A movable contact is provided on the slider 34.

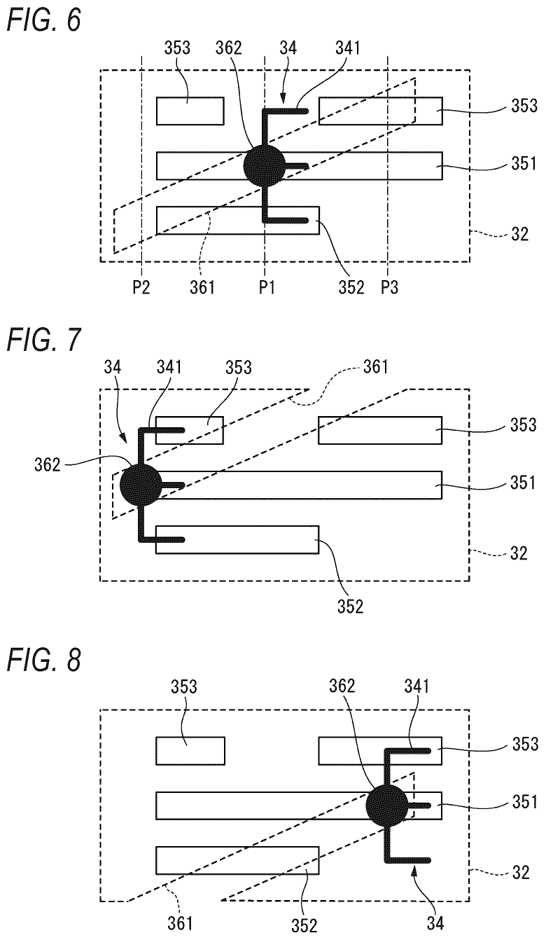

FIG. 6 schematically illustrates a positional relationship between multiple stationary contacts on the circuit board 35 and the movable contact 341 of the slider 34. The multiple stationary contacts include a first contact 351, a second contact 352, and a third contact 353. Each of the first contact 351, the second contact 352, and the third contact 353 is formed of a conductive material and is electrically insulated from each other. Each of the first contact 351, the second contact 352, and the third contact 353 extends in a direction along the turning axis X. The movable contact 341 is formed of a conductive material.

In a first position P1 of the slider 34 illustrated in FIG. 6, the movable contact 341 establishes an electrical connection with the first contact 351 and the second contact 352.

As illustrated in FIG. 5, the knob switch 3 includes a cam mechanism 36. The cam mechanism 36 includes a cam face 361 and a cam follower 362. The cam face 361 is formed as a part of the rotor 32. The cam follower 362 is formed as a part of the slider 34.

The cam face 361 is configured to displace the cam follower 362 in a direction along the turning axis X in accordance with the turning action of the knob 31. In other words, the cam mechanism 36 is configured to displace the slider 34 on the circuit board 35 along the turning axis X in accordance with the turning action of the knob 31.

FIG. 7 illustrates a case where the knob 31 is turned clockwise in FIG. 2 from the state illustrated in FIG. 6. The cam follower 362 is displaced leftward in FIG. 7 along the cam face 361, so that the slider 34 moves to the second position P2 in FIG. 6. In this state, the movable contact 341 establishes electrical connection with the first contact 351, the second contact 352, and the third contact 353.

FIG. 8 illustrates a case where the knob 31 is turned counterclockwise in FIG. 2 from the state illustrated in FIG. 6. The cam follower 362 is displaced rightward in FIG. 8 along the cam face 361, so that the slider 34 moves to the third position P3 in FIG. 6. In this state, the movable contact 341 establishes electrical connection with the first contact 351 and the third contact 353.

In other words, the movable contact 341 establishes different electrical connection states by electrically connecting the first contact 351 with at least one of the second contact 352 and the third contact 353 at each of the first position P1, the second position P2, and the third position P3 that are arranged on a displacement path of the slider 34. The first contact 351 is an example of a first stationary contact. Each of the second contact 352 and the third contact 353 is an example of a second stationary contact.

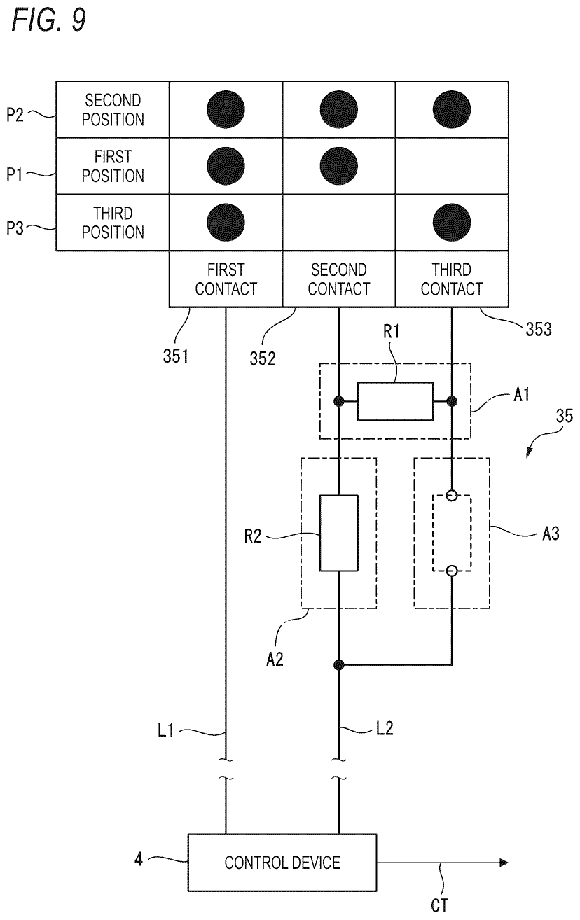

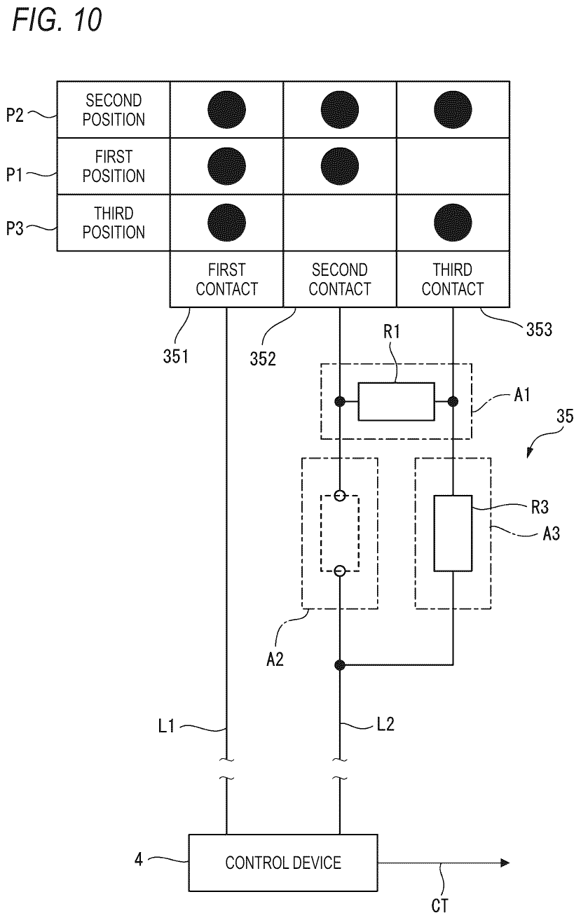

FIG. 9 schematically illustrates an exemplary configuration of the circuit board 35 according to a first exemplary embodiment. Black circles in a table in the drawing represents which one of the first contact 351, the second contact 352, and the third contact 353 is electrically connected with the movable contact 341 in a case where the slider 34 takes each of the first position P1, the second position P2, and the third position P3. As long as such a combination of electrical connection states can be realized, the layout of the first contact 351, the second contact 352, and the third contact 353 on the circuit board 35 can be appropriately determined.

The circuit board 35 includes a first area A1, a second area A2, and a third area A3. The first area A1 is electrically connected in parallel with the second contact 352 and the third contact 353. The second area A2 is electrically connected in series with the second contact 352. The third area A3 is electrically connected in series with the third contact 353.

The switch device 1 includes a signal line L1. The signal line L1 is electrically connected to the first contact 351. The signal line L1 is used, for example, to fix the first contact 351 to a specific electrical potential.

The switch device 1 includes a signal line L2. The signal line L2 is electrically connected in parallel with the second area A2 and the third area A3.

A resistive element R1 is mounted in the first area A1. The resistive element R1 is electrically connected in parallel with the second contact 352 and the third contact 353. The resistive element R1 is an example of a first resistive element.

A resistive element R2 is mounted on the second area A2. The resistive element R2 is electrically connected in series with the second contact 352. The resistive element R2 is electrically connected to the third contact 353 via the resistive element R1. The resistive element R2 is an example of a second resistive element.

In the third area A3, no resistive element is mounted, so that a land adapted to be connected with a circuit element is exposed. Accordingly, the third area A3 is substantially made open.

It should be noted that as long as such a substantial open state can be realized, a resistive element or the like having a sufficiently high resistance value may be mounted in the third area A3.

When the slider 34 is in the first position P1, a current I2 flows from the second contact 352 to the signal line L2 via the resistive element R2. When the slider 34 is at the third position P3, a current I12 flows from the third contact 353 to the signal line L2 via the resistive element R1 and the resistive element R2. When the slider 34 is at the second position P2, a combined current of the current I2 and the current I12 flows through the signal line L2.

Since the value of the current flowing through the signal line L2 is made different in accordance with the position of the slider 34, each value can be associated with one of the multiple controlled states. Examples of the multiple controlled states include multiple operation states in connection with a headlight installed in the vehicle.

A control device 4 is installed at an appropriate position in the vehicle. The control device 4 constitutes a switch system together with the switch device 1. The control device 4 is configured to detect, through the signal line L2, which one of the multiple electrical connection states is established in the circuit board 35, and to associate the electrical connection state as detected with one of the multiple controlled states. Specifically, the control device 4 is configured to output a control signal CT for realizing a corresponding controlled state based on the value of the current flowing through the signal line L2.

Such a control device 4 may be implemented by a versatile microprocessor configured to cooperate with a versatile memory. Examples of the versatile microprocessor include a CPU, an MPU, and a GPU. Examples of the versatile memory include a ROM and a RAM. In this case, one or more computer programs for implementing the functions may be stored in the ROM. The versatile microprocessor specifies at least a part of the program stored in the ROM, loads the program on the RAM, and executes the processing described above in cooperation with the RAM.

The control device 4 having various functions described above can be implemented by an exclusive integrated circuit such as a microcontroller, an ASIC, and an FPGA equipped with a storage element in which a computer program for executing the functions is pre-installed. The control device 4 may be implemented by a combination of an exclusive integrated circuit and a versatile microprocessor.

FIG. 10 illustrates another exemplary configuration of the circuit board 35 according to the first exemplary embodiment. Components substantially the same as those described with reference to FIG. 9 are assigned with the same reference numerals, and repetitive descriptions for those will be omitted.

In this example, a resistive element R3 is mounted on the third area A3. The resistive element R3 is electrically connected in series with the third contact 353. The resistive element R3 is electrically connected to the second contact 352 via the resistive element R1. A resistance value of the resistive element R3 is different from the resistance value of the resistive element R2. The resistive element R3 is an example of the second resistive element.

On the other hand, no resistive element is mounted on the second area A2, so that a land adapted to be connected with a circuit element is exposed. Accordingly, the second area A2 is substantially made open.

It should be noted that as long as such a substantial open state can be realized, a resistive element or the like having a sufficiently high resistance value may be mounted in the second area A2.

When the slider 34 is in the first position P1, a current I13 flows from the second contact 352 to the signal line L2 via the resistive element R1 and the resistive element R3. When the slider 34 is at the third position P3, a current I3 flows from the third contact 353 to the signal line L2 via the resistive element R3. When the slider 34 is at the second position P2, a combined current of the current I13 and the current I3 flows through the signal line L2.

Any values of the current obtained in the signal line L2 of the circuit board 35 according to the present example are different from the values of the current obtained in the signal line L2 of the circuit board 35 described with reference to FIG. 9. Accordingly, the control device 4 can associate at least one of the multiple electrical connection states formed in the circuit board 35 according to the present example with multiple controlled states different from the case in FIG. 9. The multiple controlled states may be a controlled state in connection with a different type of headlight or a headlight with a different function from the case of FIG. 9, or may be a controlled state in connection with another device installed in the vehicle. Examples of another device include a wiper device, and an opening/closing device for a door or a window.

As described with reference to FIGS. 9 and 10, a resistive element is mounted on one of the second area A2 and the third area A3 of the circuit board 35 so as to be connected in series with one of the multiple stationary contacts. The other of the second area A2 and the third area A3 is substantially made open.

In other words, by selecting one of the second area A2 and the third area A3 of a common circuit board 35 on which a resistive element is to be mounted, it is possible to change a controlled state to be associated with a certain electrical connection state established on the circuit board 35. Accordingly, it is possible to diversify models capable of installing a switch system while suppressing an increase in a manufacturing cost of the system.

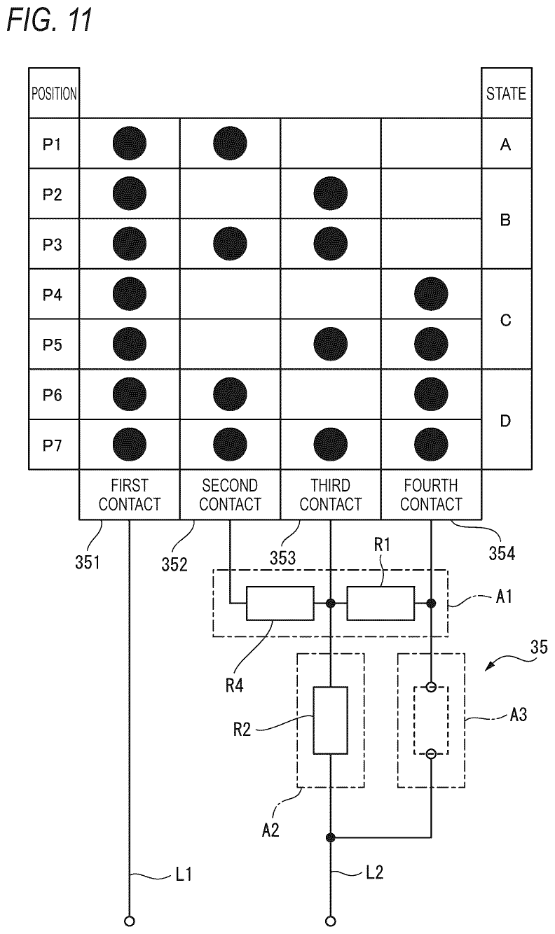

FIG. 11 schematically illustrates an exemplary configuration of a circuit board 35 according to a second exemplary embodiment. Components substantially the same as those in the first exemplary embodiment are assigned with the same reference numerals, and repetitive descriptions for those will be omitted.

A first contact 351, a second contact 352, a third contact 353, and a fourth contact 354 are formed on the circuit board 35 according to the present exemplary embodiment. A movable contact 341 electrically connects the first contact 351 with at least one of the second contact 352, the third contact 353, and the fourth contact 354 in accordance with the displacement of the slider 34, thereby establishing multiple different electrical connection states. The first contact 351 is an example of a first stationary contact. Each of the second contact 352, the third contact 353, and the fourth contact 354 is an example of the second stationary contact.

The circuit board 35 according to the present exemplary embodiment includes a first area A1, a second area A2, and a third area A3. The first area A1 is electrically connected in parallel with the second contact 352, the third contact 353, and the fourth contact 354. The second area A2 is electrically connected in series with the third contact 353. The third area A3 is electrically connected in series with the fourth contact 354.

In the first area A1, a resistive element R1 and a resistive element R4 are mounted. The resistive element R1 is electrically connected in parallel with the third contact 353 and the fourth contact 354. The resistive element R4 is electrically connected in parallel with the second contact 352 and the third contact 353. The resistive element R4 is an example of the first resistive element.

A resistive element R2 is mounted on the second area A2. The resistive element R2 is electrically connected in series with the third contact 353. The resistive element R2 is electrically connected to the second contact 352 via the resistive element R4. The resistive element R2 is electrically connected to the fourth contact 354 via the resistive element R1. The resistive element R2 is an example of a second resistive element.

In the third area A3, no resistive element is mounted, so that a land adapted to be connected with a circuit element is exposed. Accordingly, the third area A3 is substantially made open. It should be noted that as long as such a substantial open state can be realized, a resistive element or the like having a sufficiently high resistance value may be mounted in the third area A3.

When the slider 34 is at the position P1, a current I42 flows from the second contact 352 to the signal line L2 via the resistive element R4 and the resistive element R2. When the slider 34 is at the position P2, a current I2 flows from the third contact 353 to the signal line L2 via the resistive element R2. When the slider 34 is at the position P3, a combined current of the current I42 and the current I2 flows through the signal line L2. When the slider 34 is at the position P4, the current I12 flows from the fourth contact 354 to the signal line L2 via the resistive element R1 and the resistive element R2. When the slider 34 is at the position P5, a combined current of the current I2 and the current I12 flows through the signal line L2. When the slider 34 is at the position P6, a combined current of the current I42 and the current I12 flows through the signal line L2. When the slider 34 is at the position P7, a combined current of the current I42, the current I2, and the current I12 flows through the signal line L2.

Although not illustrated, the signal line L1 and the signal line L2 are connected to the control device 4. The control device 4 is configured to detect, through the signal line L2, which one of the multiple electrical connection states is established in the circuit board 35, and to associate the electrical connection state as detected with one of the multiple controlled states. Examples of the multiple controlled states include multiple operation states in connection with a headlight installed in the vehicle.

In this example, the electrical connection state established when the slider 34 is at the position P1 is associated with a state A of the headlight. The electrical connection state established when the slider 34 is at the position P2 or the position P3 is associated with a state B of the headlight. The electrical connection state established when the slider 34 is at the position P4 or the position P5 is associated with a state C of the headlight. The electrical connection state established when the slider 34 is at the position P6 or the position P7 is associated with a state D of the headlight.

The control device 4 outputs a control signal CT for realizing a corresponding controlled state based on the value of the current flowing through the signal line L2.

It should be noted that the resistance value of the resistive element R1 is preferably determined so as to be lower than the resistance value of the resistive element R4, in a case where the state C involving the current I12 has a higher priority than the state B involving the current I42. It is known that the resistance value of the resistive element tends to decrease over time. According to such a configuration, it is possible to suppress the influence of the aging of the resistance value with respect to the controlled state with the higher priority.

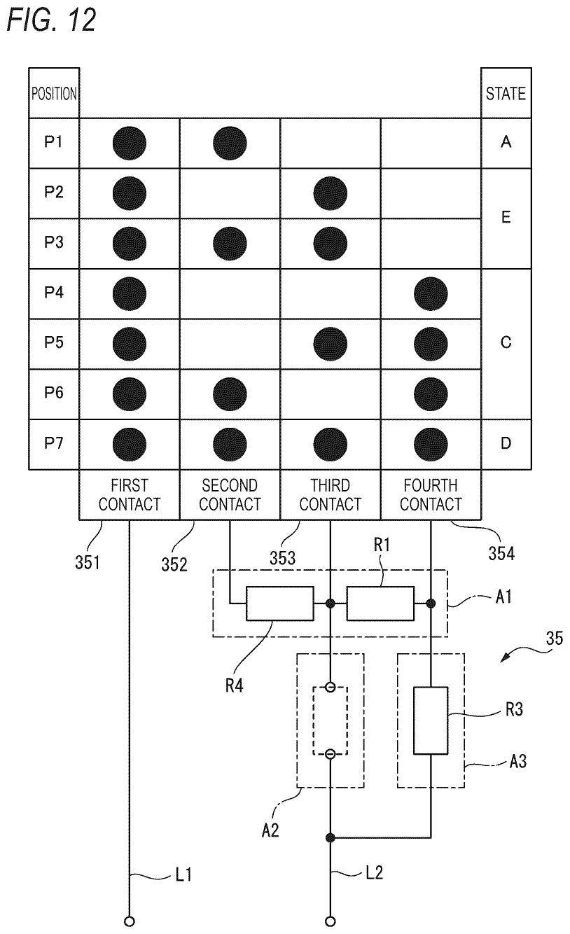

FIG. 12 illustrates another exemplary configuration of the circuit board 35 according to the second exemplary embodiment. Components substantially the same as those described with reference to FIG. 11 are assigned with the same reference numerals, and repetitive descriptions for those will be omitted.

In this example, a resistive element R3 is mounted on the third area A3. The resistive element R3 is electrically connected in series with the fourth contact 354. The resistive element R3 is electrically connected to the third contact 353 via the resistive element R1. The resistive element R3 is electrically connected to the second contact 352 via the resistive element R1 and the resistive element R4. The resistive element R3 is an example of the second resistive element.

In the second area A2, no resistive element is mounted, so that a land adapted to be connected with a circuit element is exposed. Accordingly, the second area A2 is substantially made open. It should be noted that as long as such a substantial open state can be realized, a resistive element or the like having a sufficiently high resistance value may be mounted in the second area A2.

When the slider 34 is at the position P1, a current I413 flows from the second contact 352 to the signal line L2 via the resistive element R4, the resistive element R1, and the resistive element R3. When the slider 34 is at the position P2, a current I13 flows from the third contact 353 to the signal line L2 via the resistive element R1 and the resistive element R3. When the slider 34 is at the position P3, a combined current of the current I413 and the current I13 flows through the signal line L2. When the slider 34 is at the position P4, a current I3 flows from the fourth contact 354 to the signal line L2 via the resistive element R3. When the slider 34 is at the position P5, a combined current of the current I13 and the current I3 flows through the signal line L2. When the slider 34 is at the position P6, a combined current of the current I413 and the current I3 flows through the signal line L2. When the slider 34 is at the position P7, a combined current of the current I413, the current I13, and the current I3 flows through the signal line L2.

In this example, the electrical connection state established when the slider 34 is at the position P1 is associated with the state A of the headlight. The electrical connection state established when the slider 34 is at the position P2 or the position P3 is associated with a state E of the headlight. The electrical connection state established when the slider 34 is at any one of the position P4, the position P5, and the position P6 is associated with the state C of the headlight. The electrical connection state established when the slider 34 is at the position P7 is associated with the state D of the headlight.

Accordingly, even with the configuration according to the present exemplary embodiment, by selecting one of the second area A2 and the third area A3 of a common circuit board 35 on which a resistive element is to be mounted, it is possible to change a controlled state to be associated with a certain electrical connection state established on the circuit board 35.

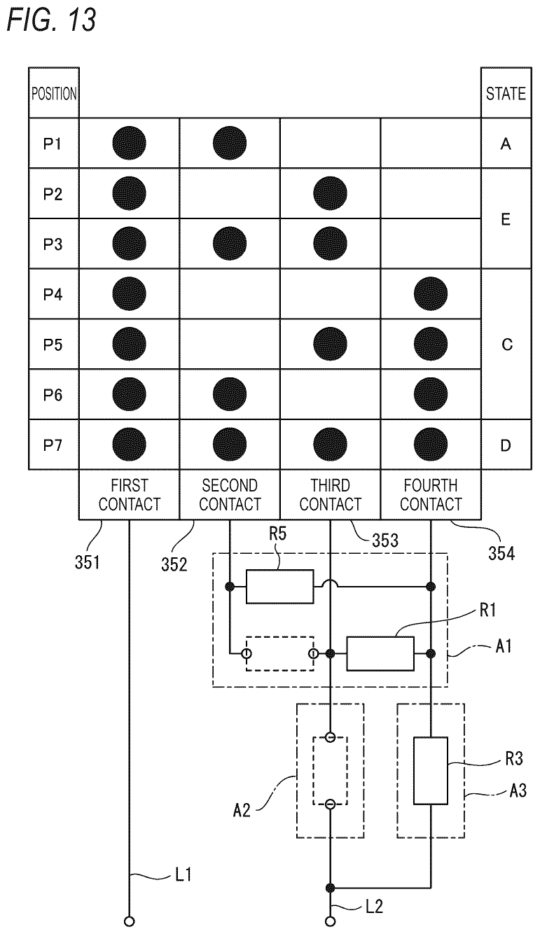

FIG. 13 schematically illustrates an exemplary configuration of a circuit board 35 according to a third exemplary embodiment. Components substantially the same as those in the second exemplary embodiment are assigned with the same reference numerals, and repetitive descriptions for those will be omitted.

In the first area A1, a resistive element R1 and a resistive element R5 are mounted. The resistive element R5 is electrically connected in parallel with the second contact 352 and the fourth contact 354. The resistive element R5 is an example of the first resistive element.

The resistive element R4 is not mounted in the first area A1 according to the present example. In the area for mounting the resistive element R4 described with reference to the second exemplary embodiment, a land adapted to be connected with a circuit element is exposed. It should be noted that as long as such a substantially open state can be realized, a resistive element or the like having a sufficiently high resistance value may be mounted in the region.

When the slider 34 is at the position P1, a current I53 flows from the second contact 352 to the signal line L2 via the resistive element R5 and the resistive element R3. When the slider 34 is at the position P2, a current I13 flows from the third contact 353 to the signal line L2 via the resistive element R1 and the resistive element R3. When the slider 34 is at the position P3, a combined current of the current I53 and the current I13 flows through the signal line L2. When the slider 34 is at the position P4, a current I3 flows from the fourth contact 354 to the signal line L2 via the resistive element R3. When the slider 34 is at the position P5, a combined current of the current I13 and the current I3 flows through the signal line L2. When the slider 34 is at the position P6, a combined current of the current I53 and the current I3 flows through the signal line L2. When the slider 34 is at the position P7, a combined current of the current I53, the current I13, and the current I3 flows through the signal line L2.

The control device 4 associates the electrical connection states with the controlled states as in the second exemplary embodiment.

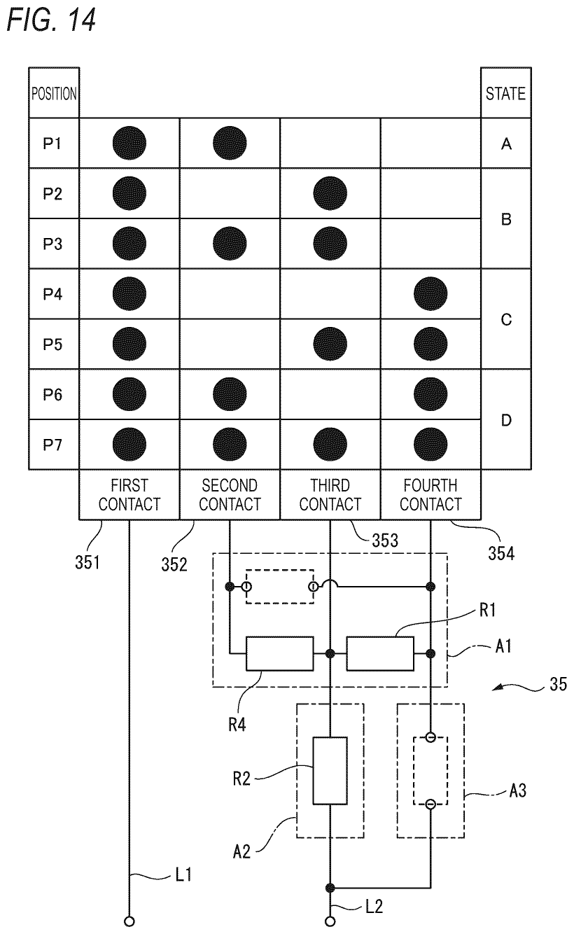

FIG. 14 illustrates another exemplary configuration of the circuit board 35 according to the third exemplary embodiment. Components substantially the same as those described with reference to FIG. 13 are assigned with the same reference numerals, and repetitive descriptions for those will be omitted.

In the first area A1, a resistive element R1 and a resistive element R4 are mounted. The resistive element R4 is electrically connected in parallel with the second contact 352 and the third contact 353. The resistive element R4 is an example of the first resistive element.

The resistive element R5 is not mounted in the first area A1 according to the present example. In the area for mounting the resistive element R5 described with reference to FIG. 13, a land adapted to be connected with a circuit element is exposed. It should be noted that as long as such a substantially open state can be realized, a resistive element or the like having a sufficiently high resistance value may be mounted in the region.

The configuration according to the present example is substantially the same as the configuration described with reference to FIG. 11. Since the operations caused by the displacement of the slider 34 are also the same, repetitive descriptions for those will be omitted.

As has been described with reference to FIGS. 13 and 14, in the circuit board 35 according to the present exemplary embodiment, in accordance with the fact that any one of the second area A2 and the third area A3 is substantially made open, an area on which at least one resistive element can be mounted is substantially made open in the first area A1 on which multiple resistive elements are to be mounted.

Accordingly, even with the configuration according to the present exemplary embodiment, by selecting one of the second area A2 and the third area A3 of a common circuit board 35 on which a resistive element is to be mounted, it is possible to change a controlled state to be associated with a certain electrical connection state established on the circuit board 35.

Each configuration described above is merely illustrative in order to facilitate understanding of the presently disclosed subject matter. Each of the above exemplary configurations can be appropriately modified or combined with another exemplary configuration within the teaching of the presently disclosed subject matter.

The switch device 1 described above may not constitute a part of the steering device. The switch device 1 may be disposed at an appropriate position in the vehicle to control the operation of another device installed in the vehicle based on the turning actuation of the knob 31. Examples of another device include an audio-visual device, an air conditioning device, and a navigation device.

The above-described switch device 1 may not be installed in a vehicle. The switch device 1 may be disposed at an appropriate position in a house or a facility to control the operation of various devices disposed in the house or the facility based on the turning actuation of the knob 31.

The above-described switch device 1 may not be configured such that one of multiple controlled states is selected in accordance with the turning actuation of the knob 31. The form of the actuable member can be appropriately selected as long as an electrical connection state is established with at least one of the multiple stationary contacts based on the displacement of the movable contact, so that one of the multiple controlled states is selected based on the electrical connection state as established. Examples of another actuable member include a slide lever, a joystick, and a button that is movable in multiple directions.

The present application is based on Japanese Patent Application No. 2023-063547 filed on Apr. 10, 2023, the entire contents of which are incorporated herein by reference.

1. A switch system, comprising:
a switch device; and
a control device,
wherein the switch device includes:
a first stationary contact;
multiple second stationary contacts;
a movable contact configured to be moved so as to electrically connect the first stationary contact with at least one of the second stationary contacts, thereby being capable of establishing multiple electrical connection states;
a circuit board including a first area, a second area, and a third area; and
a signal line connected in parallel with the second area and the third area,
wherein at least one first resistive element connected in parallel with the second stationary contacts is mounted on the first area;
wherein a second resistive element connected in series with one of the second stationary contacts is mounted on one of the second area and the third area;
wherein the other of the second area and the third area is substantially made open; and
wherein the control device is configured to detect, through the signal line, which one of the electrical connection states is established, and to associate the one of the electrical connection state as detected with one of multiple controlled states.

2. The switch system according to claim 1,
wherein the control device is configured to associate one of the electrical connection states that is detected through a path reaching the signal line via at least one of the first resistive element and the second resistive element so as to take a lower combined resistance value with one of the controlled states having a higher priority.

3. The switch system according to claim 1,
wherein in a case where multiple first resistive elements can be mounted on the first area, an area on which at least one of the first resistive elements can be mounted is substantially made open, in accordance with a fact that which one of the second area and the third area is substantially made open.

4. The switch system according to claim 1,
wherein the switch device includes an actuable member turnable about an axis; and
wherein the movable contact is moved in accordance with a turning action of the actuable member.

5. The switch system according to claim 1,
wherein the switch device constitutes a part of a steering device for changing a traveling direction of a vehicle; and
wherein the controlled states correspond to multiple operations performed by at least one device installed in the vehicle.
